(19) United States
(12) Patent Application Publication
(10) Pub. No.: US 2007/0089841 A1
(43) Pub. Date: Apr. 26, 2007

(54) HEAD RAIL AND SUPPORT BRACKET

(76) Inventors: Alejandro Martin Rossato, Greensboro, NC (US); Zazu Ciuca, Jamestown, NC (US)

Correspondence Address: MOORE & VAN ALLEN PLLC, P.O. BOX 13706, Research Triangle Park, NC, 27709, US

(21) Appl. No.: 11/163,658

(22) Filed: Oct. 26, 2005

(51) Int. Cl. E06B 9/00

(52) U.S. Cl. 160/178.1 R

(57) ABSTRACT

A bracket comprising a first wall and a second wall can be secured to a supporting surface. The walls are arranged such that the window covering head rail can be located between the walls. The first wall includes a pocket for receiving the rear upper edge of the head rail. A flange extends under the front upper edge of the head rail. A biased latch extends into the area bounded by the first and second walls and is attached to either the first or second walls. The latch includes a protrusion that engages the rear bottom edge of the head rail to clamp the head rail in the bracket. A relatively sharp barb, formed on the latch, engages the back wall of the head rail to prevent lateral movement of the head rail relative to the bracket.

The invention relates generally to window coverings such as blinds and shades and more particularly to a bracket and head rail for mounting the window covering to a surface.

A typical window covering consists of a head rail located at the top of a window that supports the body or panel of the blind such as slats, fabric, woven elements, cellular structure or the like that cover the window or other architectural feature. The body or panel of the window covering is typically movable relative to the head rail such that it can be raised or lowered to uncover or cover the window. In the case of a slatted window covering such as a Venetian blind the slats are also movable to open and/or close the lowered covering. Typically, the body or panel of the window covering is moved by lift cords and/or tilt cords or wands that are connected to the window covering and are manipulated by the end user. It is also known to move the body or panel of the window covering using a motor such as an electric motor or spring motor.

Because the window covering can be relatively heavy and is subject to forces from the manipulation of the tilt and lift cords, it is important to have a secure system for mounting the window covering to the supporting surface. Moreover, it is important that the mounting system be easily mounted to both the head rail and the supporting surface because window coverings are often installed by non-professionals. Finally, it is important that the mounting system be visually appealing such that it does not interfere with the look of the window covering.

Thus an improved head rail and mounting bracket for a window covering is desired.

### SUMMARY OF THE INVENTION

The system of the invention comprises a bracket having a first wall and a second wall that extends substantially perpendicular to the first wall. The first wall, second wall or both walls can be secured to a supporting surface such as a wall or ceiling. Both the first wall and the second wall are provided with through holes for receiving screws or other fasteners for securing the bracket to the supporting surface. The first and second walls are arranged such that the head rail can be located between the walls. The first wall includes a recessed pocket for receiving the rear upper edge of the head rail and a flange that extends under the front upper edge of the head rail. A biased latch member, attached to either the first or second walls, extends into the area bounded by the first and second walls. The latch member includes a protrusion that engages the rear bottom edge of the head rail to clamp the head rail in the bracket. A relatively sharp barb, formed on the latch, engages the back wall of the head rail to prevent lateral movement of the head rail relative to the bracket. In one embodiment the bracket is stamped and formed from a single flat piece of material such as steel such that the bracket of the invention is simple and inexpensive to manufacture.

### BRIEF DESCRIPTION OF THE DRAWINGS

FIG. 1 is a perspective view of one embodiment of the bracket of the invention.

FIG. 2 is a side view of the bracket of FIG. 1.

FIG. 3 is a back view of the bracket of FIG. 1.

FIG. 4 is a side view of the bracket and head rail showing the bracket of FIG. 1 mounted on the head rail.

FIG. 5 is a partial perspective view showing the bracket of FIG. 1 mounted on a head rail.

FIG. 6 is a perspective view of another embodiment of the bracket of the invention.

### DETAILED DESCRIPTION OF EMBODIMENTS OF THE INVENTION

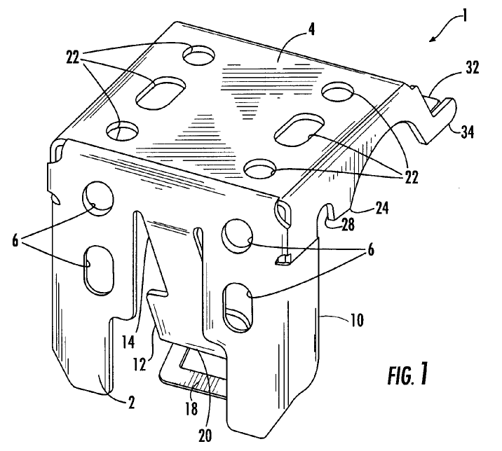

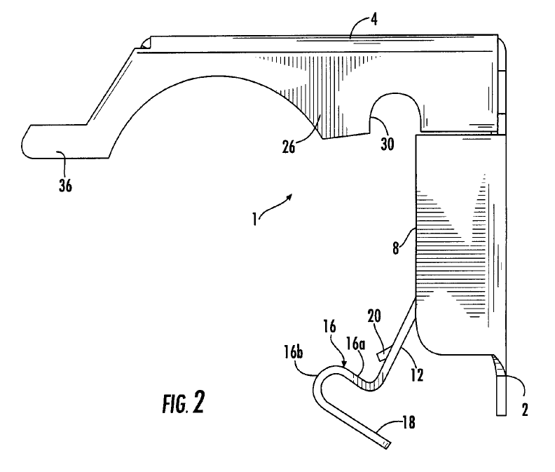

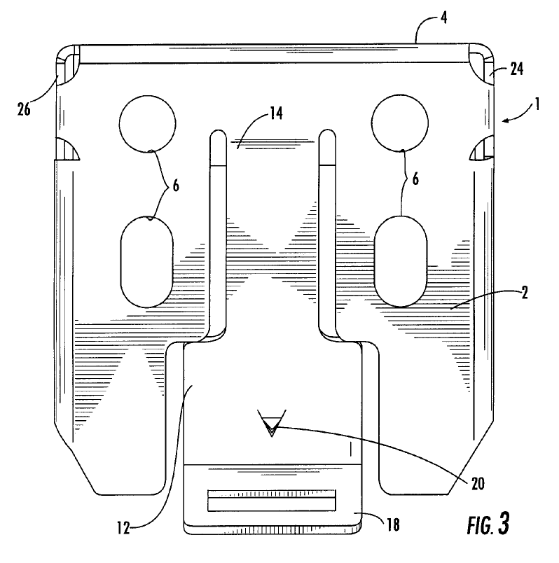

Referring to FIGS. 1 through 3, the bracket of the invention is shown generally at 1 and consists of a back wall 2 formed at a substantially right angle to top wall 4. In one embodiment bracket 1 is formed of a single piece of material such as steel. Back wall 2 includes a number of through holes 6 for receiving fasteners such as screws for mounting the bracket 1 to a substantially vertical surface such as a wall, door, window molding or the like. Flanges 8 and 10 extend from back wall 2 to engage the head rail as will hereinafter be described.

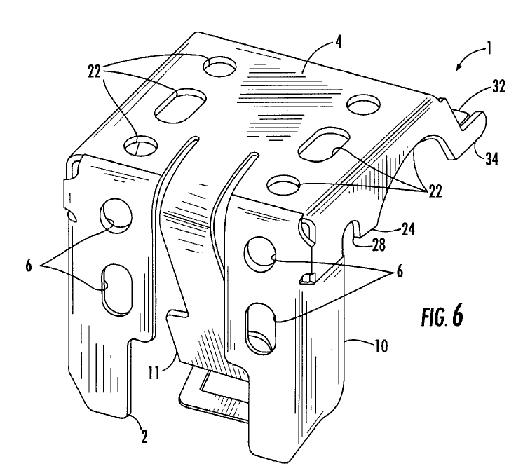

A biased latch 12 extends from adjacent the back wall 2 into the space bounded by the back wall 2 and top wall 4. In the embodiment of FIGS. 1 through 5 the latch 12 extends from back wall 2 and is formed as a cut-out portion of the back wall. In the embodiment of FIG. 6 the latch 11 is formed as a cut-out that extends though both the back wall 2 and top wall 4. The latch 12 may also be a separate member secured to the bracket such as by welding. The bias of the latch 12 is created by the living hinge formed at the bend 14 and the resiliency of the material of bracket 2 where the latch can be deformed by an external force applied thereto but will return to the position shown in FIGS. 1 through 3 when the force is removed. The distal end of latch 12 is formed with a protrusion 16 created by bending latch 12 into a substantially U-shaped configuration. Protrusion 16 may also be a separate member secured to the latch such as by welding. Protrusion 16 extends from latch 12 substantially perpendicularly thereto and consists of a latching portion 16a and a camming portion 16b. The U-shaped protrusion 16 also defines an extending lever 18 that can be pressed by the end user to release the latch from the head rail. A relatively sharp barb 20 is formed on latch 12 so as to extend toward the head rail when the bracket 1 is attached to the head rail. In the illustrated embodiment, barb 20 is formed by punching a V-shaped protrusion from latch 12. Brad 20 may also comprise a separate member connected to label 12 such as by welding.

The top wall 4 is formed with a number of through holes 22 for receiving fasteners such as screws for mounting the bracket 1 to a substantially horizontal surface such as a window frame, ceiling, window molding or the like. Flanges 24 and 26 extend from top wall 4 to engage the head rail as will hereinafter be described. Flanges 24 and 26 include recessed pockets 28 and 30, respectively, that are aligned with one another and dimensioned so as to fit over the upper edge of the head rail back wall. Top wall 4 terminates in a lip 32 that is also comprised of extending portions 34 and 36 of flanges 24 and 26, respectively.

To manufacture the bracket of the invention, a flat piece of steel or other rigid material is cut by stamping or other process into a blank having the outline and cut outs shown in the drawings. The barb or protrusion 20 is punched out of latch 12. Flanges 8, 10, 24 and 26 are formed by bending the portions defining the flanges relative to the top wall 4 and back wall 2. The top wall 4 is bent relative to the back wall 4 to create the basic L-shape. The latch 12 is bent relative to either the top or back walls at living hinge 14 and the protrusion 16 and lever 18 are formed at the end of latch 12. Thus the bracket of the invention can be made simply and inexpensively.

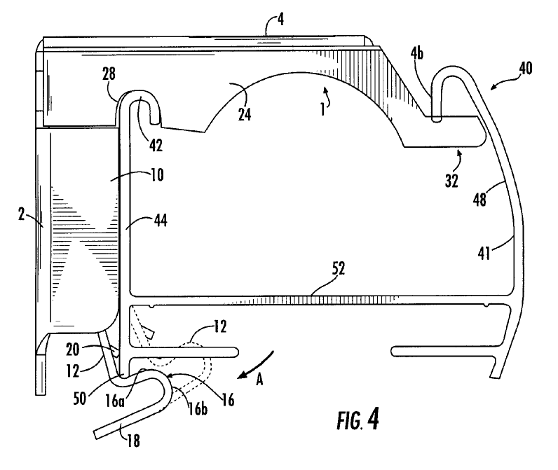

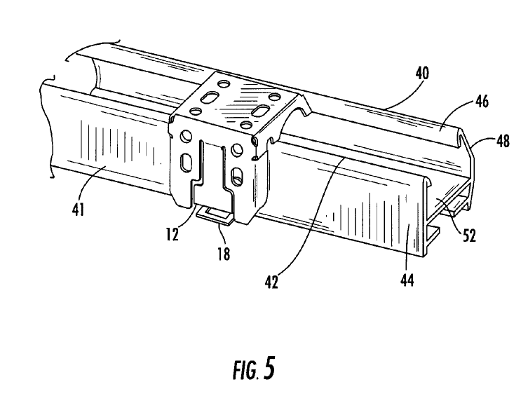

A head rail 40 is shown mounted to the bracket 1 in FIGS. 4 and 5. Head rail 40 comprises an elongated member 41 that supports the window covering body or panel (not shown). Typically, the head rail 40 extends the width of the panel or body and includes a front wall 48, rear wall 44 and bottom wall 52 where the area bounded by the walls contains the lift and/or tilt mechanisms. The upper edge 42 of rear wall 44 may include a rolled edge and is located in pockets 28 and 30 formed as recesses in flanges 24 and 26. Edge 42 extends completely into recessed pockets 28 and 30 such that it contacts the inner surface of the pockets. Lip 32 is located under the upper edge 46 of front wall 48 where the upper edge 46 may be formed as a rolled edge. The edges of flanges 8 and 10 abut the rear wall 44. Protrusion 16 of latch 12 engages the lower edge 50 of rear wall 44. Because latch 12 is deformed from its normal biased position (shown in dashed lines in FIG. 4) when head rail 40 is mounted in bracket 1, latch 12 exerts a force on the head rail 40 forcing the upper edge 42 of rear wall 44 into engagement with the pockets 28 and 30. The rear wall 44 is essentially clamped between the latch 12 and the pockets 28 and 30. The upper edge 46 of front wall 48 sits on top of lip 32. Barb 20 digs into the surface of head rail 32 to prevent the head rail from moving laterally relative to the bracket 2.

To mount the head rail 40 on a support surface, bracket 1 is attached to a surface such as a wall, ceiling, window frame, molding or the like by screws or other fasteners that extend through the through holes 6 and/or 22 and into the surface. The bracket may be mounted to the surface using other attachment devices. In a typical application the more than one bracket will be used to mount the head rail covering to the surface where the brackets are mounted in a common plane.

Once bracket 1 is mounted to the supporting surface, head rail 40 is located with edge 42 fully inserted in pockets 28 and 30 and lip 32 located below upper edge 46. Head rail 40 is rotated such that the lower edge 50 is moved towards latch 12 (clockwise as shown by arrow A in FIG. 4). As head rail 40 is rotated in the direction of arrow A, edge 50 engages the camming portion 16b of protrusion 16 and slides over the camming portion as the head rail 40 forces the latch 12 toward back wall 2. When the head rail is in the position shown in FIG. 4, the lower edge 50 of head rail 40 clears the camming portion 16b and the latch 12 springs forward to trap lower edge 50 and clamp the back wall 44 between pockets 28 and 30 and latch 12 with flanges 8 and 10 contacting back wall 44. Lip 32 is positioned under top edge 46 to support the front edge of the head rail. To release the head rail from the bracket, pressure is exerted on lever 18 until the latching portion 16a of latch 12 clears the lower edge 50 and allows the head rail to be pivoted in the direction opposite arrow A and free from bracket 1.

The invention has been described with specific reference to “window coverings”. The use of the term “window covering” has been used herein to simplify the description. It is to be understood that the bracket and window covering may be used to cover structures such as doors or other architectural features or may be used as a room divider or the like.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

What is claimed is:

1. A bracket and head rail system comprising:
a head rail having a back wall having a first upper edge and a lower edge;
a bracket having a pocket for receiving the first upper edge, a movable latch member trapping the lower edge wherein said latch member has a barb formed thereon for engaging the head rail; said latch member normally biased to a first position and moved to a second position when the head rail is inserted in the bracket such that the latch member exerts a force on the head rail.

2. The system of claim 1 wherein the head rail includes a front wall having an second upper edge, a portion of the bracket extending below the upper edge.

3. The system of claim 1 wherein said first upper edge is fully inserted into said pocket.

4. The system of claim 1 wherein the movable latch includes a protrusion that engages the lower edge.

5. The system of claim 1 wherein the protrusion includes a camming surface.

6. The system of claim 5 wherein the camming surface is contacted by the head rail when the head rail is inserted into the bracket to move the latch from the first position to the second position.

7. The system of claim 1 wherein the latch extends from a back wall of the bracket.

8. The system of claim 1 wherein the latch extends from a top wall of the bracket.

9. The system of claim 7 wherein a flange extends from the back wall of the bracket and contacts the back wall of the head rail.

10. The system of claim 1 wherein the latch includes a lever for releasing the bracket from the head rail.

11. The system of claim 1 wherein the bracket is made of a single, unitary piece of material.

12. The system of claim 1 wherein the back wall of the head rail is clamped between the recess and the latch.

13. The system of claim 1 wherein said bracket includes a back wall and the latch is formed as a cut out of the back wall.

14. The system of claim 1 wherein the bracket includes a back wall and a top wall and the latch is formed as a cut out of the top wall and the back wall.

15. The system of claim 1 wherein the bracket further defines a through hole for receiving a fastener.

16. The system of claim 1 wherein the latch is biased at a living hinge.

17. The system of claim 1 wherein the latch is made of a resilient material such that the force is provided at least in part by the resiliency of the material of the latch.

18. The system of claim 1 wherein the bracket includes a top wall and a back wall, said pocket extending from said top wall and said latch extending from said back wall.

19. The system of claim 18 further including a pair of flanges extending from said back wall and engaging said head rail.

20. The system of claim 2 wherein the first upper edge and the second upper edge are rolled.
